(19) United States
(12) Patent Application Publication
(10) Pub. No.: US 2025/0013547 A1
(43) Pub. Date: Jan. 9, 2025

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp., Tokyo (JP)

(72) Inventor: Manabu WADA, Kanagawa (JP)

(73) Assignee: FUJIFILM Business Innovation Corp., Tokyo (JP)

(21) Appl. No.: 18/434,849

(22) Filed: Feb. 7, 2024

(30) Foreign Application Priority Data
Jul. 6, 2023 (JP) 2023-111631

(51) Int. Cl. G06F 11/27; G06F 11/14

(52) U.S. Cl. CPC G06F 11/27; G06F 11/1417

(57) ABSTRACT

An information processing system includes one or plural processors configured to: detect tampering of hardware that is mounted on an information processing apparatus and configured to execute first processing; in a case where second processing has not been executed or has not been scheduled to be executed by the information processing apparatus, restart the information processing apparatus to achieve recovery from the tampering; and in a case where the second processing has been executed or has been scheduled to be executed, when a predetermined condition is satisfied, restart the information processing apparatus to achieve recovery from the tampering.

### CROSS-REFERENCE TO RELATED APPLICATIONS

This application is based on and claims priority under 35 USC 119 from Japanese Patent Application No. 2023-111631 filed Jul. 6, 2023.

### BACKGROUND

### (i) Technical Field

The present disclosure relates to an information processing system, an information processing method, and a non-transitory computer readable medium.

### (ii) Related Art

The power of hardware, such as a facsimile card, that is mounted on an information processing apparatus and configured to execute predetermined processing may be turned OFF in order that power consumption during the standby time is saved. However, during the power OFF state, there is a risk of tampering. Thus, a technique for confirming, at the time when the power of the hardware is turned OFF from ON, whether or not tampering has occurred and making recovery from the tampering when tampering is detected has been known (for example, Japanese Unexamined Patent Application Publication No. 2020-082441). In the technique mentioned above, for recovery from tampering, the information processing apparatus is restarted.

### SUMMARY

However, in the case where the information processing apparatus is restarted in order that recovery from the tampering is achieved, since restrictions are placed on the execution of a job regarding another processing that was executed prior to the restart or was scheduled, prior to the restart, to be executed, user-friendliness for a user who uses the information processing apparatus may be degraded.

Aspects of non-limiting embodiments of the present disclosure relate to, compared to a case where restart for recovery from tampering of mounted hardware is performed without any restrictions, suppressing degradation of user-friendliness caused by the restart.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including one or a plurality of processors configured to: detect tampering of hardware that is mounted on an information processing apparatus and configured to execute first processing; in a case where second processing has not been executed or has not been scheduled to be executed by the information processing apparatus, restart the information processing apparatus to achieve recovery from the tampering; and in a case where the second processing has been executed or has been scheduled to be executed, when a predetermined condition is satisfied, restart the information processing apparatus to achieve recovery from the tampering.

### BRIEF DESCRIPTION OF THE DRAWINGS

Exemplary embodiments of the present disclosure will be described in detail based on the following figures, wherein:

FIG. 1 is a diagram illustrating an example of the entire configuration of an information processing system according to an exemplary embodiment;

FIG. 2 is a diagram illustrating an example of the hardware configuration of an image processing apparatus;

FIG. 3 is a diagram illustrating an example of the functional configuration of a controller of the image processing apparatus;

FIG. 4 is a diagram illustrating an example of the functional configuration of a controller of a user terminal;

FIG. 5 is a flowchart illustrating an example of the flow of a process of the image processing apparatus;

FIGS. 6A and 6B are diagrams illustrating a specific example of a process in the case where hardware that is mounted on the image processing apparatus and configured to execute first processing is a facsimile card that executes transmission and reception of a facsimile document via a telephone line and the facsimile card has been tampered with;

FIG. 7 is a diagram illustrating a specific example of a process in the case where one of a plurality of facsimile cards mounted on the image processing apparatus has been tampered with; and

FIG. 8 is a diagram illustrating a specific example of a user interface displayed on the image processing apparatus.

### DETAILED DESCRIPTION

Hereinafter, exemplary embodiments of the present disclosure will be described in detail with reference to the attached drawings.

### <Configuration of Information Processing System>

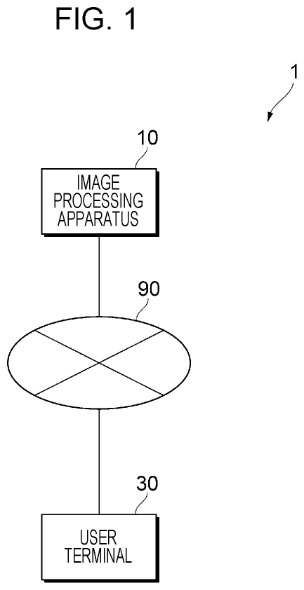

FIG. 1 is a diagram illustrating an example of the entire configuration of an information processing system 1 according to an exemplary embodiment.

The information processing system 1 is configurated in such a manner that an image processing apparatus 10 and a user terminal 30 are connected via a network 90. The network 90 is, for example, a local area network (LAN), the Internet, a public line network, or the like.

### (Image Processing Apparatus)

The image processing apparatus 10 is an information processing apparatus that performs various types of processing in accordance with input operations performed by a user who uses the information processing system 1. For example, the image processing apparatus 10 performs processing for forming an image on a medium such as paper, processing for outputting a recording medium on which an image is formed, reading processing for reading an image formed on paper or other media, processing for performing facsimile transmission of a read image, processing for acquiring various types of transmitted information, and the like. The image processing apparatus 10 is, for example, a multifunction machine of a so-called electrophotographic system that forms a toner image on a printing surface of paper, a printer of a so-called inkjet system that discharges ink to a printing surface of paper, or the like.

The image processing apparatus 10 stores various types of information into databases and manages the various types of information. Furthermore, the image processing apparatus 10 acquires various types of information transmitted from the user terminal 30 via the network 90 and performs various types of processing. The image processing apparatus 10 also transmits various types of information to the user terminal 30.

For example, the image processing apparatus 10 checks tampering of hardware that is mounted on the image processing apparatus 10 and configured to execute first processing. When the image processing apparatus 10 detects tampering, in the case where second processing has not been executed or has not been scheduled to be executed by the image processing apparatus 10, the image processing apparatus 10 restarts to achieve recovery from the detected tampering. The “hardware that is configured to execute first processing” represents, for example, a facsimile card that executes transmission and reception of facsimile documents. The “second processing” represents printing processing.

When the image processing apparatus 10 detects tampering, in the case where second has been executed or has been scheduled to be executed processing by the image processing apparatus 10, if a predetermined condition is satisfied, the image processing apparatus 10 restarts to achieve recovery from the tampering. For example, when the second processing by the image processing apparatus 10 is completed as the “predetermined condition”, the image processing apparatus 10 restarts to achieve recovery from the tampering of the hardware that is mounted on the image processing apparatus 10 and configured to execute the first processing.

In the case where the user terminal 30 that remotely operates the image processing apparatus 10 is connected to the image processing apparatus 10, the image processing apparatus 10 provides to the user terminal 30 a notification indicating that the hardware mounted on the image processing apparatus 10 and configured to execute the first processing has been tampered with and the image processing apparatus 10 is capable of executing processing different from the first processing. In this case, the image processing apparatus 10 executes the processing different from the first processing in accordance with an instruction from the user terminal 30.

Furthermore, in the case where a plurality of pieces of hardware are mounted on the image processing apparatus 10 and there is a piece of hardware that is capable of executing the first processing and is not tampered with among the plurality of pieces of hardware, the image processing apparatus 10 provides to the user terminal 30 a notification indicating that a plurality of pieces of hardware are mounted on the image processing apparatus 10 and there is a piece of hardware that is capable of executing the first processing and is not tampered with among the plurality of pieces of hardware. In this case, in accordance with an instruction from the user terminal 30, the image processing apparatus 10 executes the first processing using the hardware that is not tampered with.

Furthermore, in accordance with an instruction from the user terminal 30 as the “predetermined condition” described above, the image processing apparatus 10 restarts to achieve recovery from the tampering of the hardware that is mounted on the image processing apparatus 10 and configured to execute the first processing. In this case, the image processing apparatus 10 displays on the user terminal 30 a user interface for instructing the image processing apparatus 10 to restart.

When the image processing apparatus 10 detects tampering of the hardware that is mounted on the image processing apparatus 10 and configured to execute the first processing, the image processing apparatus 10 does not turn OFF the power of the hardware and maintains the ON state of the hardware until recovery from the tampering has been achieved. During this ON period, the image processing apparatus 10 does not execute the first processing. The details of a configuration and a process of the image processing apparatus 10 will be described later.

### (User Terminal)

The user terminal 30 is an information processing apparatus, such as a smartphone, a tablet terminal, or a personal computer, that a user who uses the information processing system 1 operates. Application software that allows the user terminal 30 to operate the image processing apparatus 10 is installed in the user terminal 30. The user terminal 30 acquires various types of information transmitted from the image processing apparatus 10 and performs various types of processing. For example, when control information for displaying information indicating that hardware that is mounted on the image processing apparatus 10 and configured to execute the first processing has been tampered with is transmitted to the user terminal 30, the user terminal 30 displays the information indicating that the hardware has been tampered with. Furthermore, when control information for displaying information indicating that the image processing apparatus 10 is capable of executing processing different from the first processing is transmitted to the user terminal 30, the user terminal 30 displays the information indicating that the image processing apparatus 10 is capable of executing the processing different from the first processing. Furthermore, when control information for displaying information indicating that hardware that is not tampered with is capable of executing the first processing is transmitted to the user terminal 30, the user terminal 30 displays the information indicating that the hardware that is not tampered with is capable of executing the first processing.

Furthermore, the user terminal 30 transmits various types of information to the image processing apparatus 10. For example, the user terminal 30 transmits to the image processing apparatus 10 information input to cause the image processing apparatus 10 to perform various types of processing. For example, the user terminal 30 transmits to the image processing apparatus 10 information input to cause the image processing apparatus 10 to execute the second processing. Furthermore, the user terminal 30 transmits information input to cause hardware that is not tampered with to execute the first processing. Furthermore, the user terminal 30 transmits to the image processing apparatus 10 information input to restart the image processing apparatus 10. The details of a configuration and a process of the user terminal 30 will be described later.

The configuration of the information processing system 1 described above is merely an example. The information processing system 1 in its entirety needs to have functions for executing the processing described above. Thus, part of or all the functions for executing the processing described above may be shared or cooperated in the information processing system 1. That is, part of or all the functions of the user terminal 30 may be provided in the image processing apparatus 10 or part of or all the functions of the image processing apparatus 10 may be provided in the user terminal 30. Furthermore, part of or all the functions of the user terminal 30 and the image processing apparatus 10 that configurate the information processing system 1 may be transferred to other servers not illustrated in drawings. Thus, processing as the entire information processing system 1 may be promoted and a plurality of types of processing may complement each other.

### (Hardware Configuration of Image Processing Apparatus)

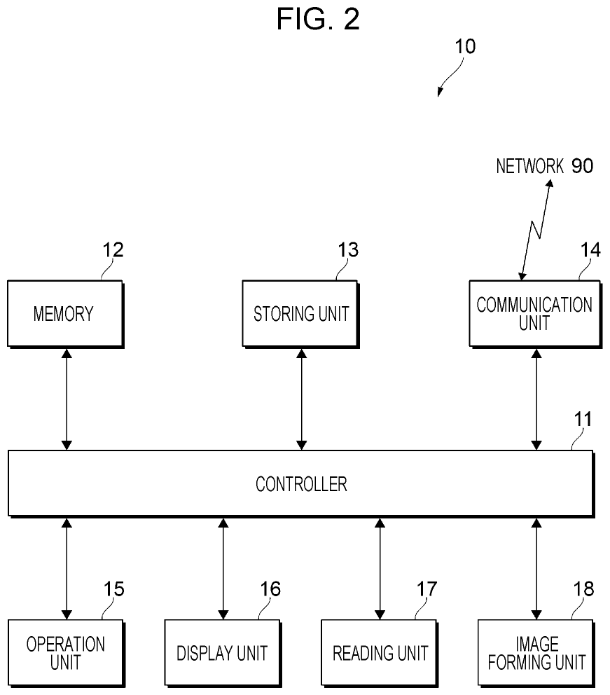

FIG. 2 is a diagram illustrating an example of the hardware configuration of the image processing apparatus 10.

The image processing apparatus 10 includes a controller 11, a memory 12, a storing unit 13, a communication unit 14, an operation unit 15, a display unit 16, a reading unit 17, and an image forming unit 18. These units are connected by a data bus, an address, bus, a peripheral component interconnect (PCI) bus, or the like.

The controller 11 is a processor that controls functions of the user terminal 30 through execution of various types of software such as operating software (OS) and application software. The controller 11 includes, for example, a central processing unit (CPU). The memory 12 is a storage region in which various types of software and data used for execution of the various types of software are stored and is used as a work area for calculation. The memory 12 includes, for example, a random access memory (RAM).

The storing unit 13 is a storage region in which data to be input to various types of software, data output from various types of software, and the like are stored. The storing unit 13 includes, for example, a hard disk drive (HDD), a solid state drive (SSD), a semiconductor memory, or the like used for storing programs and various types of setting data. Databases in which various types of information are stored are provided in the storing unit 13.

The communication unit 14 performs transmission and reception of data to and from the user terminal 30 and other devices via the network 90. The operation unit 15 includes, for example, a software keyboard, mechanical buttons, switches, and the like and receives an input operation. The operation unit 15 also includes a touch sensor that forms a touch panel to be integrated with the display unit 16. The display unit 16 includes, for example, a liquid crystal display or an organic electroluminescence (EL) display used for displaying information and displays data of images, text, and the like.

The reading unit 17 reads an image recorded on a medium (for example, a document of a paper medium) such as paper as a recording medium. The reading unit 17 includes, for example, a scanner of a charge coupled devices (CCD) type that reduces, with a lens, reflected light with respect to light radiated from a light source to a document and receives, with CCD, the light, a scanner of a contact image sensor (CIS) type that receives, with a CIS, reflected light with respect to light sequentially radiated from a light-emitting diode (LED) light source to a document, or the like. The image forming unit 18 forms, for example, using an electrophotographic system or an inkjet system, an image as a printing target on a printing surface of paper as a recording medium. These units are connected by a data bus, an address bus, a PCI bus, or the like.

### (Hardware Configuration of User Terminal)

The hardware configuration of the user terminal 30 is similar to the hardware configuration of the image processing apparatus 10 illustrated in FIG. 2 with the exception of the reading unit 17 and the image forming unit 18. That is, the user terminal 30 includes a controller, a memory, a storing unit, a communication unit, an operation unit, and a display unit that have functions similar to functions of the controller 11, the memory 12, the storing unit 13, the communication unit 14, the operation unit 15, and the display unit 16, and illustration in drawings and description of these units are omitted.

### <Functional Configuration of Controller of Image Processing Apparatus>

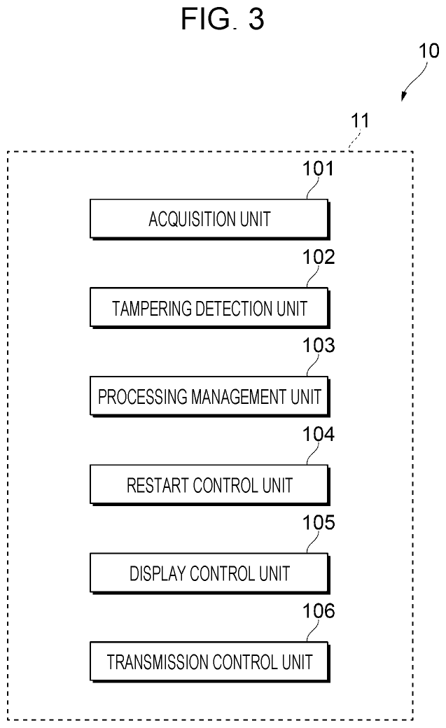

FIG. 3 is a diagram illustrating an example of the functional configuration of the controller 11 of the image processing apparatus 10.

In the controller 11 of the image processing apparatus 10, an acquisition unit 101, a tampering detection unit 102, a processing management unit 103, a restart control unit 104, a display control unit 105, and a transmission control unit 106 function.

The acquisition unit 101 acquires various types of information. For example, the acquisition unit 101 acquires various types of information transmitted from the user terminal 30. The information transmitted from the user terminal 30 is, for example, information input to cause the image processing apparatus 10 to execute processing different from the first processing, information input to cause hardware that is not tampered with to execute the first processing, information input to restart the image processing apparatus 10, or the like.

The tampering detection unit 102 detects tampering of hardware that is mounted on the image processing apparatus 10 and configured to execute the first processing.

The processing management unit 103 manages execution of the second processing by the image processing apparatus 10. Furthermore, the processing management unit 103 manages scheduled execution of the second processing by the image processing apparatus 10.

The restart control unit 104 performs control for restarting the image processing apparatus 10. For example, when tampering of hardware that is mounted on the image processing apparatus 10 and configured to execute the first processing is detected, in the case where the second processing by the image processing apparatus 10 has not been executed or has not been scheduled to be executed, the restart control unit 104 restarts the image processing apparatus 10 to achieve recovery from the detected tampering. At this time, the restart control unit 104 performs control for enabling the hardware that is configured to execute the first processing to be in the non-tampered state when the image processing apparatus 10 is restarted.

Furthermore, when tampering of the hardware that is mounted on the image processing apparatus 10 and configured to execute the first processing is detected, in the case where the second processing by the image processing apparatus 10 has been executed or has been scheduled to be executed, if a predetermined condition is satisfied, the restart control unit 104 performs control for restarting the image processing apparatus 10 to achieve recovery from the detected tampering. At this time, the restart control unit 104 performs control for enabling the hardware that is configured to execute the first processing to be in the non-tampered state when the image processing apparatus 10 is restarted. The “predetermined condition” is, for example, that the second processing by the image processing apparatus 10 is completed, an instruction to restart the image processing apparatus 10 has been issued from the user terminal 30, or the like.

The display control unit 105 performs control for displaying various types of information on the display unit 16 (see FIG. 2). For example, the display control unit 105 performs control for displaying on the display unit 16 information indicating that the hardware that is mounted on the image processing apparatus 10 and configured to execute the first processing has been tampered with. Furthermore, the display control unit 105 performs control for displaying on the display unit 16 information indicating that the image processing apparatus 10 is capable of executing different processing.

Furthermore, the display control unit 105 performs control for displaying various types of information on the display unit of the user terminal 30. Specifically, the display control unit 105 transmits to the user terminal 30 control information for displaying various types of information on the display unit of the user terminal 30. For example, the display control unit 105 performs control for displaying on the display unit of the user terminal 30 information indicating that the hardware that is mounted on the image processing apparatus 10 and configured to execute the first processing has been tampered with and information indicating that the image processing apparatus 10 is capable of executing different processing.

Furthermore, in the case where a plurality of pieces of hardware are mounted on the image processing apparatus 10 and there is a piece of hardware that is capable of executing the first processing and is not tampered with among the plurality of pieces of hardware, the display control unit 105 performs control for displaying on the display unit of the user terminal 30 information indicating that a plurality of pieces of hardware are mounted on the image processing apparatus 10 and there is a piece of hardware that is capable of executing the first processing and is not tampered with among the plurality of pieces of hardware. Furthermore, the display control unit 105 performs control for displaying on the display unit of the user terminal 30 a user interface for issuing an instruction to restart the image processing apparatus 10.

The transmission control unit 106 performs control for transmitting various types of information via the communication unit 14 (see FIG. 2). Specifically, the transmission control unit 106 performs control for transmitting various types of information to the user terminal 30. For example, the transmission control unit 106 performs control for transmitting control information for displaying various types of information on the user terminal 30.

The control information for displaying various types of information on the user terminal 30 is, for example, control information for displaying information indicating that hardware that is mounted on the image processing apparatus 10 and configured to execute the first processing has been tampered with or control information for displaying information indicating that the image processing apparatus 10 is capable of executing different processing. Furthermore, for example, the control information for displaying various types of information on the user terminal 30 is control information for displaying information indicating that there is hardware that is capable of executing the first processing and is not tampered with, control information for displaying a user interface for issuing an instruction to restart the image processing apparatus 10, or the like.

### (Functional Configuration of Controller of User Terminal)

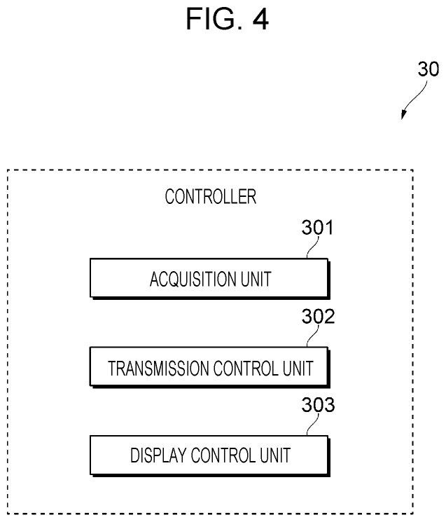

FIG. 4 is a diagram illustrating an example of the functional configuration of the controller of the user terminal 30.

In the controller of the user terminal 30, an acquisition unit 301, a transmission control unit 302, and a display control unit 303 function.

The acquisition unit 301 acquires various types of information. For example, the acquisition unit 301 acquires input information received by the operation unit of the user terminal 30. Furthermore, the acquisition unit 301 acquires various types of information transmitted from the image processing apparatus 10 and external devices. Information transmitted from the image processing apparatus 10 and acquired by the acquisition unit 301 is, for example, control information for displaying on the user terminal 30 information indicating that hardware that is mounted on the image processing apparatus 10 and configured to execute the first processing has been tampered with, control information for displaying on the user terminal 30 information indicating that the image processing apparatus 10 is capable of executing processing different from the first processing, control information for displaying on the user terminal 30 information indicating that hardware that is not tampered with is capable of executing the first processing, or the like.

The transmission control unit 302 performs control for transmitting various types of information via the communication unit. Specifically, the transmission control unit 302 performs control for transmitting various types of information to the image processing apparatus 10 and external devices. For example, the transmission control unit 302 performs control for transmitting to the image processing apparatus 10 input information acquired by the acquisition unit 301. The input information transmitted to the image processing apparatus 10 is, for example, information input to cause the image processing apparatus 10 to execute the second processing, information input to cause hardware that is not tampered with to execute the first processing, information input to restart the image processing apparatus 10, or the like.

The display control unit 303 performs control for displaying various types of information on the display unit. For example, the display control unit 303 performs control for displaying in a shared manner on the display unit an operation screen of the image processing apparatus 10. Furthermore, the display control unit 303 performs control for displaying on the display unit information indicating that hardware that is mounted on the image processing apparatus 10 and configured to execute the first processing has been tampered with. Furthermore, the display control unit 303 performs control for displaying on the display unit information indicating that the image processing apparatus 10 is capable of executing processing different from the first processing. Furthermore, the display control unit 303 performs control for displaying on the display unit information indicating that hardware that is not tampered with is capable of executing the first processing.

### <Flow of Process>

### (Flow of Process of Image Processing Apparatus>

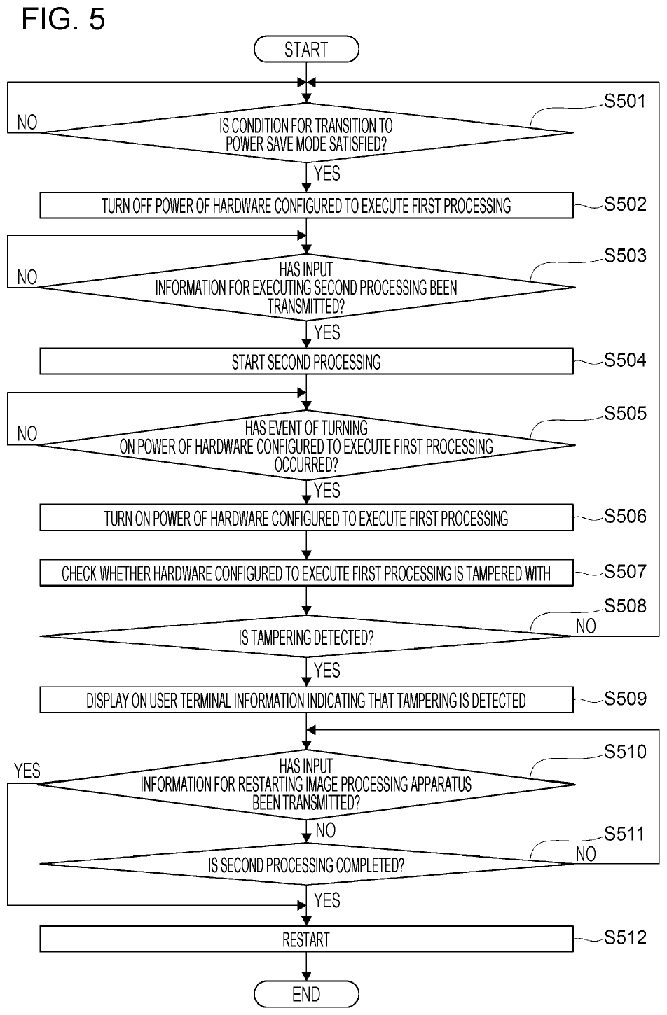

FIG. 5 is a flowchart illustrating an example of the flow of a process of the image processing apparatus 10.

When a condition for transition to a power save mode is satisfied (YES in step 501), the image processing apparatus 10 turns OFF the power of hardware that is mounted on the image processing apparatus 10 and configured to execute the first processing (step 502). In contrast, in the case where the condition for transition to the power save mode is not satisfied (NO in step 501), the image processing apparatus 10 repeats the determination processing of step 501 until the condition for transition to the power save mode is satisfied.

Then, when input information for executing the second processing is transmitted from the user terminal 30 to the image processing apparatus 10 (YES in step 503), the image processing apparatus 10 starts the second processing (step 504). In contrast, in the case where the input information for executing the second processing is not transmitted from the user terminal 30 to the image processing apparatus 10 (NO in step 503), the image processing apparatus 10 repeats the determination processing of step 503 until the input information for executing the second processing is transmitted from the user terminal 30 to the image processing apparatus 10.

When an event of turning ON the power of the hardware that is configured to execute the first processing has occurred (YES in step 505), the image processing apparatus 10 turns ON the power of the hardware that is configured to execute the first processing (step 506), and confirms whether or not the hardware that is configured to execute the first processing is tampered with (step 507). In contrast, in the case where the event of turning ON the power of the hardware that is configured to execute the first processing has not occurred (NO in step 505), the image processing apparatus 10 repeats the determination processing of step 505 until the event of turning ON the power of the hardware that is configured to execute the first processing has occurred.

When the image processing apparatus 10 detects tampering of the hardware that is configured to execute the first processing (YES in step 508), the image processing apparatus 10 displays on the user terminal 30 information indicating that tampering is detected (step 509). At this time, the information indicating that tampering is detected may be displayed on the screen of the display unit 16 of the image processing apparatus 10 (see FIG. 2) and the screen may be displayed in a shared manner on the user terminal 30. In the case where tampering of the hardware that is configured to execute the first processing is not detected (NO in step 508), the process of the image processing apparatus 10 returns to the determination processing of step 501.

When input information for restarting the image processing apparatus 10 is transmitted from the user terminal 30 to the image processing apparatus 10 (YES in step 510), the image processing apparatus 10 restarts to achieve recovery from the detected tampering (step 512), and ends the process (END). Furthermore, even in the case where the input information for restarting the image processing apparatus 10 has not been transmitted from the user terminal 30 to the image processing apparatus 10 (NO in step 510), if the second processing by the image processing apparatus 10 is completed (YES in step 511), the image processing apparatus 10 restarts to achieve recovery from the detected tampering (step 512), and ends the process (END).

In contrast, in the case where the input information for restarting the image processing apparatus 10 has not been transmitted from the user terminal 30 to the image processing apparatus 10 (NO in step 510) and the second processing by the image processing apparatus 10 is not completed (NO in step 511), the process of the image processing apparatus 10 returns to the determination processing of step 510.

### Specific Example

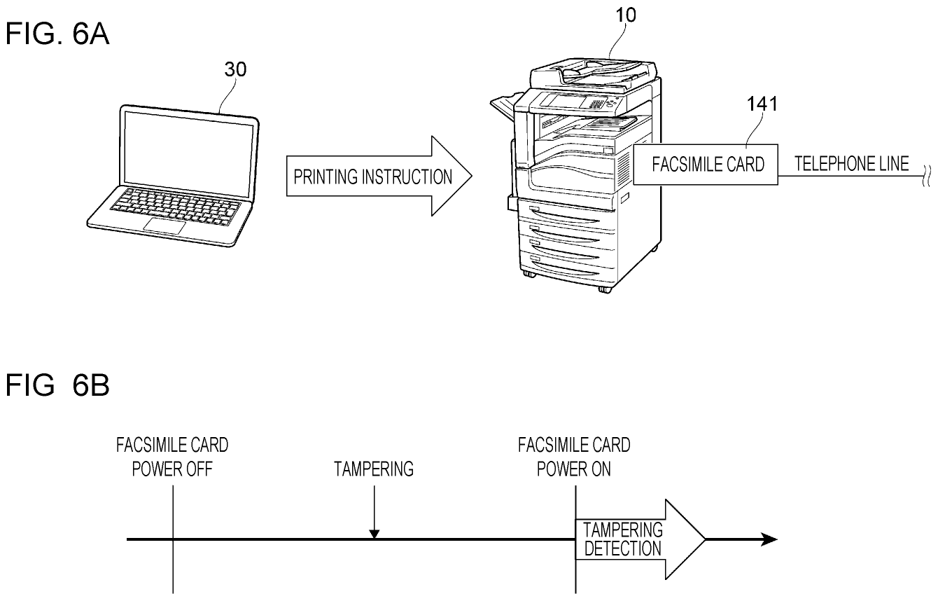

FIGS. 6A and 6B are diagrams illustrating a specific example of a process in the case where hardware that is mounted on the image processing apparatus 10 and configured to execute the first processing is a facsimile card that executes transmission and reception of a facsimile document via a telephone line and the facsimile card has been tampered with.

As illustrated in FIG. 6A, when the condition for transition to the power save mode is satisfied, the image processing apparatus 10 on which a facsimile card 141 is mounted turns OFF the power of the facsimile card 141, as illustrated in FIG. 6B. Here, it is assumed that the facsimile card 141 is tampered with. Then, when, as a “printing instruction” illustrated in FIG. 6A, input information for executing printing processing, is transmitted from the user terminal 30 to the image processing apparatus 10, the image processing apparatus 10 starts the printing processing.

After starting the printing processing, when the image processing apparatus 10 detects an incoming call to the facsimile card 141, the image processing apparatus 10 turns ON the power of the facsimile card 141, as illustrated in FIG. 6B, and checks whether or not the facsimile card 141 has been tampered with. When the image processing apparatus 10 detects that the facsimile card 141 has been tampered with, the image processing apparatus 10 displays on the user terminal 30 information indicating that the image processing apparatus 10 has detected tampering of the facsimile card 141. At this time, the image processing apparatus 10 does not turn OFF the power of the facsimile card 141 and maintains the ON state of the facsimile card 141 until recovery from the tampering has been achieved. During this ON period, the image processing apparatus 10 does not allow the facsimile card 141 to execute transmission and reception of a facsimile document.

When the input information for restarting the image processing apparatus 10 is transmitted from the user terminal 30 to the image processing apparatus 10, the image processing apparatus 10 restarts to achieve recovery from the tampering. Furthermore, even in the case where the input information for restarting the image processing apparatus 10 has not been transmitted from the user terminal 30 to the image processing apparatus 10, if the printing processing by the image processing apparatus 10 is completed, the image processing apparatus 10 restarts to achieve recovery from the tampering.

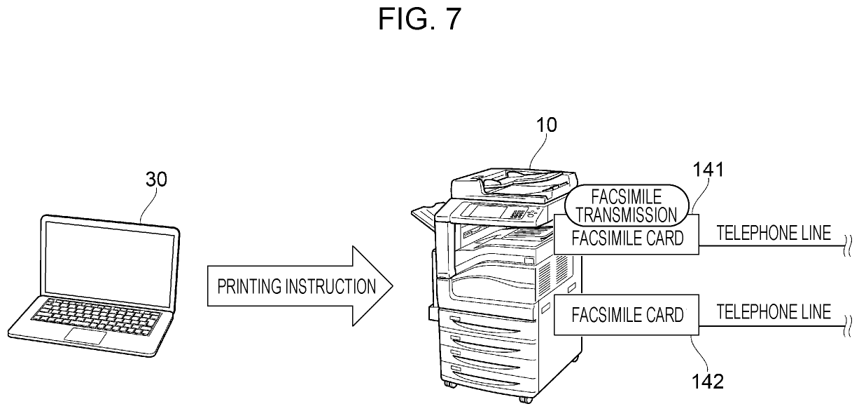

FIG. 7 is a diagram illustrating a specific example of a process in the case where one of a plurality of facsimile cards mounted on the image processing apparatus 10 has been tampered with.

As illustrated in FIG. 7, when a condition for transition to the power save mode is satisfied, the image processing apparatus 10 on which facsimile cards 141 and 142 are mounted turns OFF the power of the facsimile cards 141 and 142. It is assumed that the facsimile card 141 is tampered with but the facsimile card 142 is not tampered with. Then, when, as a “printing instruction” from the user terminal 30, input information for executing printing processing, is transmitted to the image processing apparatus 10, the image processing apparatus 10 starts the printing processing.

After starting the printing processing, when the image processing apparatus 10 detects an incoming call to the facsimile card 141, the image processing apparatus 10 turns ON the power of the facsimile card 141 and checks whether or not the facsimile card 141 has been tampered with. When the image processing apparatus 10 detects that the facsimile card 141 has been tampered with, the image processing apparatus 10 displays on the user terminal 30 information indicating that tampering of the facsimile card 141 has been detected. At this time, the image processing apparatus 10 does not turn OFF the power of the facsimile card 141 and maintains the ON state of the facsimile card 141 until recovery from the tampering has been achieved. During this ON period, the image processing apparatus 10 does not allow the facsimile card 141 to execute transmission and reception of a facsimile document.

Then, in the case where the facsimile card 142 is capable of executing transmission and reception of a facsimile document and is not tampered with, the image processing apparatus 10 notifies the user terminal 30 that the facsimile card 142 is capable of executing transmission and reception of a facsimile document and is not tampered with. In this case, the image processing apparatus 10 executes transmission and reception of a facsimile document using the facsimile card 142, which is not tampered with, in accordance with an instruction from the user terminal 30.

When input information for restarting the image processing apparatus 10 is transmitted from the user terminal 30 to the image processing apparatus 10, the image processing apparatus 10 restarts to achieve recovery from the tampering. Furthermore, even in the case where the input information for restarting the image processing apparatus 10 has not been transmitted from the user terminal 30 to the image processing apparatus 10, if the printing processing is completed, the image processing apparatus 10 restarts to achieve recovery from the tampering.

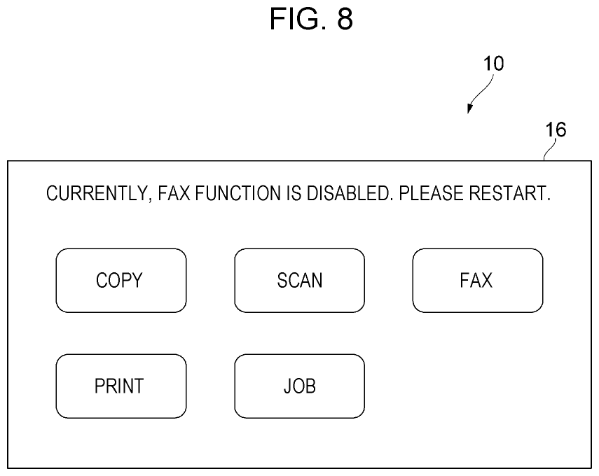

FIG. 8 is a diagram illustrating a specific example of a user interface displayed on the image processing apparatus 10.

When the image processing apparatus 10 detects tampering, in the case where the second processing is being executed or is scheduled to be executed, a screen illustrated in FIG. 8 is displayed on the display unit 16 of the image processing apparatus 10. Five types of operation buttons “COPY”, “SCAN”, “FAX”, “PRINT”, and “JOB” and a message “Currently, FAX function is disabled. Please restart.”, which indicates that tampering has been detected, are displayed on the screen illustrated in FIG. 8. The screen illustrated in FIG. 8 is also displayed in a shared manner on the user terminal 30, and the screen allows the user terminal 30 to perform a remote operation.

A user learns, from the information displayed on the screen illustrated in FIG. 8, that restart is required to use facsimile and the user is able to use copy, scan, print, and job. In the example of FIG. 8, the five types of operation buttons “COPY”, “SCAN”, “FAX”, “PRINT”, and “JOB” are displayed in similar manners. However, only the button “FAX” may be deactivated in such a manner that the user is not able to press the “FAX” button.

### Other Exemplary Embodiments

The exemplary embodiment has been described above. However, the present disclosure is not limited to the exemplary embodiment described above. Furthermore, effects achieved by the present disclosure are not limited to those described in the foregoing exemplary embodiment. For example, the configuration of the information processing system 1 illustrated in FIG. 1 and the hardware configuration of the image processing apparatus 10 illustrated in FIG. 2 are merely examples provided to attain advantages of the present disclosure and are not particularly limited. Furthermore, the functional configuration of the image processing apparatus 10 illustrated in FIG. 3 and the functional configuration of the user terminal 30 illustrated in FIG. 4 are merely examples and are not particularly limited. As long as the information processing system 1 in FIG. 1 is provided with functions capable of executing the processing described above in its entirety, a functional configuration to be used to implement the functions is not limited to the examples in FIGS. 3 and 4.

Furthermore, the order of steps in the process of the image processing apparatus 10 illustrated in FIG. 5 is merely an example and is not particularly limited. Processing steps are not necessarily performed in the illustrated order of steps in a chronological manner and may be performed concurrently or individually. Furthermore, the specific examples illustrated in FIGS. 6A and 6B and FIGS. 7 and 8 are merely examples and are not particularly limited.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system comprising:
one or a plurality of processors configured to:
   detect tampering of hardware that is mounted on an information processing apparatus and configured to execute first processing;
   in a case where second processing has not been executed or has not been scheduled to be executed by the information processing apparatus, restart the information processing apparatus to achieve recovery from the tampering; and
   in a case where the second processing has been executed or has been scheduled to be executed, when a predetermined condition is satisfied, restart the information processing apparatus to achieve recovery from the tampering.
      (((2)))

The information processing system according to (((1))), wherein the one or the plurality of processors are configured to, when tampering of the hardware is detected, not turn OFF power of the hardware and not allow the hardware to execute the first processing until recovery from the tampering has been achieved.

(((3)))

The information processing system according to (((1))) or (((2))), wherein the one or the plurality of processors are configured to:
transmit, to a terminal of a user who remotely operates the information processing apparatus, information indicating that the hardware has been tampered with and information indicating that the information processing apparatus is capable of executing different processing that is different from the first processing by the hardware that has been tampered with; and
cause the different processing to be executed in accordance with an instruction from the user.
   (((4)))

The information processing system according to (((3))), wherein the one or the plurality of processors are configured to, in a case where a plurality of pieces of hardware are mounted, cause a piece of hardware that is not tampered with, out of the plurality of pieces of hardware, to execute the first processing in accordance with the instruction from the user.

(((5)))

The information processing system according to (((3))) or (((4))), wherein the one or the plurality of processors are configured to, when an instruction to restart the information processing apparatus is issued by the user who operates the terminal as the predetermined condition, restart the information processing apparatus to achieve recovery from the tampering.

(((6)))

The information processing system according to any one of (((3))) to (((5))), wherein the one or the plurality of processors are configured to display on the terminal a user interface for issuing an instruction to restart the information processing apparatus.

(((7)))

The information processing system according to any one of (((1))) to (((3))), wherein the one or the plurality of processors are configured to:
in a case where the second processing has been executed or has been scheduled to be executed, set a schedule to restart to achieve recovery from the tampering; and
when the second processing is completed as the predetermined condition, restart the information processing apparatus to achieve recovery from the tampering.
   (((8)))

A program for causing a computer to execute:
a function for detecting tampering of hardware that is mounted on an information processing apparatus and configured to execute first processing;
a function for, in a case where second processing has not been executed or has not been scheduled to be executed by the information processing apparatus, restarting the information processing apparatus to achieve recovery from the tampering; and
a function for, in a case where the second processing has been executed or has been scheduled to be executed, when a predetermined condition is satisfied, restarting the information processing apparatus to achieve recovery from the tampering.

What is claimed is:

1. An information processing system comprising:
one or a plurality of processors configured to:
detect tampering of hardware that is mounted on an information processing apparatus and configured to execute first processing;
in a case where second processing has not been executed or has not been scheduled to be executed by the information processing apparatus, restart the information processing apparatus to achieve recovery from the tampering; and
in a case where the second processing has been executed or has been scheduled to be executed, when a predetermined condition is satisfied, restart the information processing apparatus to achieve recovery from the tampering.

2. The information processing system according to claim 1, wherein the one or the plurality of processors are configured to, when tampering of the hardware is detected, not turn OFF power of the hardware and not allow the hardware to execute the first processing until recovery from the tampering has been achieved.

3. The information processing system according to claim 2, wherein the one or the plurality of processors are configured to:
transmit, to a terminal of a user who remotely operates the information processing apparatus, information indicating that the hardware has been tampered with and information indicating that the information processing apparatus is capable of executing different processing that is different from the first processing by the hardware that has been tampered with; and
cause the different processing to be executed in accordance with an instruction from the user.

4. The information processing system according to claim 3, wherein the one or the plurality of processors are configured to, in a case where a plurality of pieces of hardware are mounted, cause a piece of hardware that is not tampered with, out of the plurality of pieces of hardware, to execute the first processing in accordance with the instruction from the user.

5. The information processing system according to claim 3, wherein the one or the plurality of processors are configured to, when an instruction to restart the information processing apparatus is issued by the user who operates the terminal as the predetermined condition, restart the information processing apparatus to achieve recovery from the tampering.

6. The information processing system according to claim 5, wherein the one or the plurality of processors are configured to display on the terminal a user interface for issuing an instruction to restart the information processing apparatus.

7. The information processing system according to claim 3, wherein the one or the plurality of processors are configured to:
in a case where the second processing has been executed or has been scheduled to be executed, set a schedule to restart to achieve recovery from the tampering; and
when the second processing is completed as the predetermined condition, restart the information processing apparatus to achieve recovery from the tampering.

8. An information processing method comprising:
detecting tampering of hardware that is mounted on an information processing apparatus and configured to execute first processing;
in a case where second processing has not been executed or has not been scheduled to be executed by the information processing apparatus, restarting the information processing apparatus to achieve recovery from the tampering; and
in a case where the second processing has been executed or has been scheduled to be executed, when a predetermined condition is satisfied, restarting the information processing apparatus to achieve recovery from the tampering.

9. A non-transitory computer readable medium storing a program causing a computer to execute a process comprising:
detecting tampering of hardware that is mounted on an information processing apparatus and configured to execute first processing;
in a case where second processing has not been executed or has not been scheduled to be executed by the information processing apparatus, restarting the information processing apparatus to achieve recovery from the tampering; and
in a case where the second processing has been executed or has been scheduled to be executed, when a predetermined condition is satisfied, restarting the information processing apparatus to achieve recovery from the tampering.
